(19) United States
(12) Patent Application Publication
(10) Pub. No.: US 2008/0005077 A1
(43) Pub. Date: Jan. 3, 2008

(54) ENCODED VERSION COLUMNS OPTIMIZED FOR CURRENT VERSION ACCESS

(76) Inventors: Thomas J. Eggebraaten, Rochester, MN (US); Jeffrey W. Tenner, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/427,418

(22) Filed: Jun. 29, 2006

(51) Int. Cl. G06F 17/30

(52) U.S. Cl. 707/3

(57) ABSTRACT

Embodiments of the present invention provide techniques for optimizing access to different versions of records within a database. Embodiments of the invention optimize the access to different versions of records by using an encoded version column (EVC) within database tables. Furthermore, embodiments of the invention provide a method for assigning EVC values for data records which have an EVC. Access to versions of records within a database table containing an EVC may be optimized based on the EVC value.

### BACKGROUND OF THE INVENTION

1. Field of the Invention

The present invention generally relates to data processing and more particularly to maintaining data version information.

2. Description of the Related Art

Databases are computerized information storage and retrieval systems. The most prevalent type of database is the relational database, a tabular database in which data is defined so that it can be reorganized and accessed in a number of different ways. A relational database management system is a computer database management system (DBMS) that uses relational techniques for storing and retrieving data. A collection of multiple types of databases is commonly referred to as a data warehouse.

It is generally understood that data is added to a data warehouse, but data is never removed from a data warehouse. A common description of this type of data warehouse is a “nonvolatile” warehouse. The primary reason for data warehouses to be nonvolatile is to allow a query which is to be run in the future to return the same results as if the query was run today. Various techniques are used to create or maintain a nonvolatile data warehouse.

One technique to maintain a nonvolatile database is to use duplicate or snapshot tables containing older versions of records (e.g., database table rows) containing old data. A disadvantage to this approach is the amount of data stored in the data warehouse can become excessive. The amount of data increases and becomes excessive because unchanged records are duplicated in the duplicate or snapshot tables. Furthermore, queries for data within the data warehouse become more complicated. The queries become more complicated because multiple tables containing different versions of records must be searched to complete the queries.

Another technique to maintain a nonvolatile database is to retain multiple versions of records containing data in a database table, and store along with each record version a pair of timestamps. The timestamps may represent the start and end times of the validity of the data within each record. Thus, the timestamps may indicate the time range a particular record is or was valid. The timestamps may also be used to determine if the record within a table is the most current, or if not, what version of the data the record represents. The disadvantage to this technique is that timestamps are typically inefficient to query and add complexity when querying data.

Therefore, there is a need for an improved and more efficient technique for maintaining older records containing data within a database in the presence of updated records.

### SUMMARY OF THE INVENTION

Embodiments of the present invention generally provide methods and apparatus for optimizing access to different versions of records and data within a database.

One embodiment of the invention provides a method of versioning data in a database. The method generally comprises: storing data in a first record of a database table having an encoded version column, wherein the first record has an encoded version column value; receiving revised data for the first record; creating a second record for the revised data, wherein the second record has an encoded version column value; calculating a first adjusted encoded version column value from the encoded version column value of the first record; associating the first adjusted encoded version column value with the first record; calculating a second adjusted encoded version column value from the encoded version column value of the first record; associating the second adjusted encoded version column value with the second record; wherein the adjusted encoded version column values identify the relative versions of the first and second records.

Another embodiment of the invention provides a computer readable medium containing a program. The program, when executed, performs operations for generating a version value for records in a database. The operations generally comprise: storing data in a first record of a database table having an encoded version column, wherein the first record has an encoded version column value; receiving revised data for the first record; creating a second record for the revised data, wherein the second record has an encoded version column value; calculating a first adjusted encoded version column value from the encoded version column value of the first record; associating the first adjusted encoded version column value with the first record; calculating a second adjusted encoded version column value from the encoded version column value of the first record; and associating the second adjusted encoded version column value with the second record; wherein the adjusted encoded version column values identify the relative versions of the first and second records.

Another embodiment of the invention provides a system. The system generally comprises a processor and a memory. The memory generally contains a database table, wherein the database table comprises: a plurality of records and a plurality of columns wherein at least one column is an encoded version column containing encoded version column values that indicate a relative version of the records within the database table; a first record that contains a nonnegative encoded version column value; and a second record relatively older than the first record with a negative encoded version column value.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary networked computer system 100, in which embodiments of the present invention may be utilized.

FIG. 2 is a flowchart illustrating a method of creating and maintaining data version control information with regards to data in a database, according to one embodiment of the invention.

FIGS. 3A-C are exemplary database tables containing an encoded version column, according to one embodiment of the invention.

### DETAILED DESCRIPTION OF THE PREFERRED EMBODIMENTS

Embodiments of the present invention provide techniques for optimizing access to different versions of records within a database. Embodiments of the invention optimize the access to different versions of records by using an encoded version column (EVC) within database tables. Furthermore, embodiments of the invention provide a method for assigning EVC values for data records which have an EVC. Access to versions of records within a database table containing an EVC may be optimized based on the EVC value.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system such as, for example, the network environment 100 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### Exemplay Database Environment

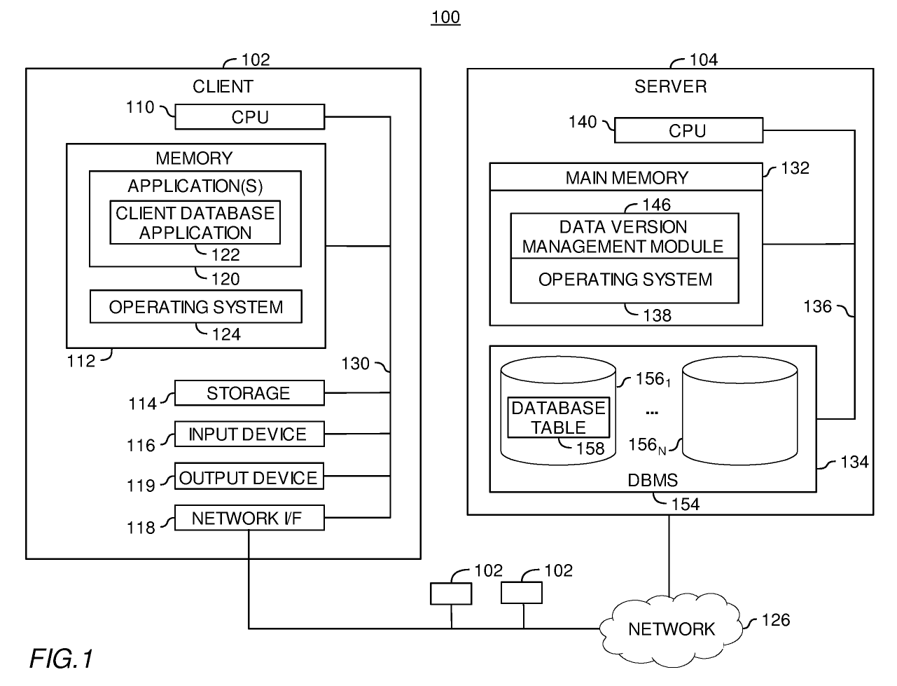

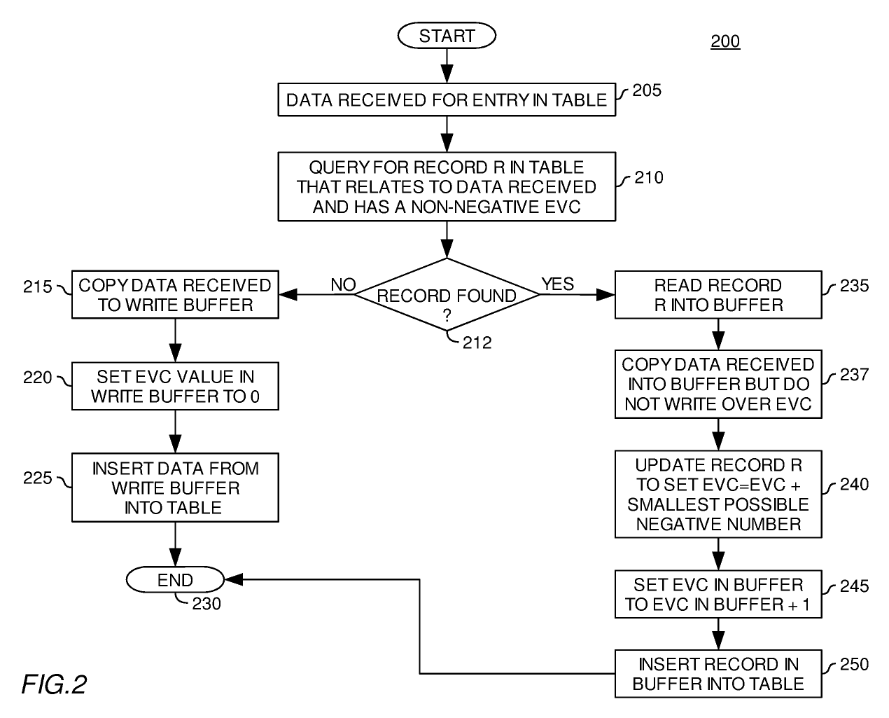

FIG. 1 shows an exemplary networked computer system 100, in which embodiments of the present invention may be utilized. For example, embodiments of the present invention may be implemented as a program product for use with the system 100, to generate a EVC value corresponding to data entered into a database table. The data version management module 146 may perform operations, as described below with respect to FIG. 2, related to generating or updating EVC values when data is entered into a database table 158.

As illustrated in FIG. 1, the system 100 generally includes client computers 102 and at least one server computer 104, connected via a network 126. In general, the network 126 may be a local area network (LAN) and/or a wide area network (WAN). In a particular embodiment, the network 126 is the Internet.

As illustrated, the client computers 102 generally include a Central Processing Unit (CPU) 110 connected via a bus 130 to memory 112, storage 114, an input device 116, an output device 119, and a network interface device 118. The input device 116 can be any device to give input to the client computer 102. For example, a keyboard, keypad, light-pen, touch-screen, track-ball, or speech recognition unit, audio/video player, and the like could be used as the input device. The output device 119 can be any device to give output to the user (e.g., any conventional display screen). Although shown separately from the input device 116, the output device 119 and input device 116 could be combined. For example, a client 102 may include a display screen with an integrated touch-screen or a display with an integrated keyboard.

The network interface device 118 may be any entry/exit device configured to allow network communications between the client 102 and the server 104 via the network 126. For example, the network interface device 118 may be a network adapter or other network interface card (NIC). If the client 102 is a handheld device, such as a personal digital assistant (PDA), the network interface device 118 may comprise any suitable wireless interface to provide a wireless connection to the network 126.

Storage 114 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 112 and storage 114 could be part of one virtual address space spanning multiple primary and secondary storage devices.

The memory 112 is preferably a random access memory (RAM) sufficiently large to hold the necessary programming and data structures of the invention. While the memory 112 is shown as a single entity, it should be understood that the memory 112 may in fact comprise a plurality of modules, and that the memory 112 may exist at multiple levels, from high speed registers and caches to lower speed but larger DRAM chips.

Illustratively, the memory 112 contains an operating system 124. Examples of suitable operating systems, which may be used include Linux and Microsoft's Windows®, as well as any operating systems designed for handheld devices, such as Palm OS®, Windows® CE, and the like. More generally, any operating system supporting the functions disclosed herein may be used.

The memory 112 is also shown containing a client database application 122, that, when executed on CPU 110, provides support for access to data within databases 156 located on a server 104. The client database application 122 may also provide support to input new versions of data into the database 156 located on the server 104.

The server 104 may be physically arranged in a manner similar to the client computer 102. Accordingly, the server 104 is shown generally comprising a CPU 140, a memory 132 and a storage device 134, coupled to one another by a bus 136. Memory 132 may be a random access memory sufficiently large to hold the necessary programming and data structures that are located on the server 104.

The server 104 is generally under the control of an operating system 138 shown residing in memory 132. Examples of the operating system 138 include IBM AIX®, UNIX, Microsoft Windows®, Linux and the like. (Linux is a trademark of Linus Torvalds in the US, other countries or both). More generally, any operating system capable of supporting the functions described herein may be used. The server may also contain a database management system (DBMS) 154, which controls the organization, storage and retrieval of information contained within databases 156_{1-N}. A database table 158 is located within one of the databases 156_{1-N}. While only one database table is shown, it is understood that the databases 156_{1-N} may each contain one or more tables.

As illustrated, the server 104 may be configured with a data version management module 146 to generate an EVC value associated with data entered into the databases 156_{1-N}. Although the data version management module 146 is illustrated as residing in the memory 146 of the server 104, as can be appreciated by those skilled in the art, the data version management module 146 may reside at other locations within the networked computer system 100. For example, the data version management module 146 may reside within memory 112 of a client machine 102.

### An Exemplary Method of Creating and Updating the Encoded Version Colomn

In order to maintain a nonvolatile database, older versions of data must be maintained within the database over time. An EVC with EVC values allows a nonvolatile database to be maintained in an efficient manner and simultaneously optimizes access to current versions of data within the database. According to one embodiment of the invention, within a database using an encoded version column to maintain data version information, the most current version of a record will have a non-negative encoded version column value (i.e., either a zero value or a positive value). Older non-current versions of records may have a negative encoded version column value.

FIG. 2 is a flowchart illustrating a method 200 of creating and maintaining encoded version column values for data input into a database, according to one embodiment of the invention. The method 200 begins at step 205 when data is received by a database management system for entry into a database. For example, the database management system may be the database management system 154 illustrated with respect to FIG. 1. The reception of data in the database management system 154 may initiate the running of a program on the server computer 104. For example, the reception of data in the database management system 154 may initiate the data version management module 146 residing in the memory 132 of the server computer 104. As data is received, the data may be written into a temporary storage buffer. The data version management module 146 may execute tasks related to the remainder of the method 200.

After the database management system 154 has received data, at step 210 the data version management module 146 may query the database table 158 for a record in the table that relates to the data received in step 205 and includes an associated attribute indicating that the record is the most recent version of the record available. In one embodiment, identifying the most recent version of a given record includes determining whether the record has a non-negative EVC value. In this way, the data version management module 146 searches for the most recent version of data related to the data received in step 205.

Next, at step 212 the data version management module 146 may determine if a record was found within the database table 158 which relates to the data received and has a non-negative EVC value. If not, processing proceeds to step 215 where the data version management module 146 creates a new original record in the database table 158 with the data received.

At step 215 the data version management module 146 may copy the data received to a write buffer. The write buffer may include a location within the buffer for version data (e.g., the EVC data value). Next, at step 220 the data version management module 146 may set the EVC data value for the data within the write buffer to zero. This zero value for the EVC column represents that this is an original record containing the data received in the table 158. After step 220, the data version management module 146 may proceed to step 225. At step 225 the data version management module 146 may insert the new record in the write buffer into the database table 158. After step 225 the data version management module 146 may proceed to step 230 where the method 200 ends.

However, if at step 212 the data version management module 146 determined that the data received in step 205 does relate to a record in a database table 158, the data version management module 146 may proceed to step 235 to execute tasks related to inserting a new version of an existing record into the database table 158 and assigning EVC values to the new version of the data and the now old version of data.

Specifically, at step 235, the data version management module 146 may read the record (i.e., the existing record in the database table 158 which relates to the data received) from the database table 158 into a buffer. The existing record may be read into the buffer (including the existing record's EVC value) so that operations may be performed to derive an EVC value for the new record. At step 237, the new data received (step 205) by the database management system 154 is used to update the buffer. As the new data is copied into the buffer in step 237 the EVC value is not changed. As described later in method 200 the record in the buffer may be written into the database table as a new version of the record.

Next, at step 240, the data version management module 146 may set/update the EVC value for the existing record in the database table 158. According to one embodiment of the invention the data version management module 146 may set the EVC value of the existing record in the database table 158 to a new value equal to its current EVC value plus the smallest possible negative value for the field (i.e., new EVC value for existing record=current EVC value+smallest possible negative value for the field). The new EVC value for the existing record will indicate that this version of the record is no longer the most recent version of the record.

For example, in one embodiment of the invention, the EVC field variable type may be a small integer. (A person of ordinary skill in the art will recognize that the variable type for the EVC field may be set to other size values as well (e.g., large integer, big integer)). In this case, the smallest possible negative number for the field may be a negative 32,768 (−32,768). Furthermore, if the existing record in the database was the original record, the EVC value of the existing record would be zero. Therefore, in step 240 the data version management module 146 would set the EVC value of the existing record to its current value plus the smallest negative integer value. This would result in the new EVC value being −32,768 (new EVC=0+−32768).

After the data version management module has set the EVC value for the existing record, at step 245 the data version management module 146 may set the EVC value for the new record located within the buffer. The new record located in the buffer contains the new data for entry into the table. The data version management module 146 may change the EVC value for the new record by adding the integer value ‘1’ to the EVC value in the buffer (new EVC=old EVC+1).

For example, if the existing record read into the buffer at step 235 was the original record, then the EVC value of the existing record would be equal to zero. The data version management module 146 may then calculate the EVC value for the new record by adding one to the EVC value in the buffer. Therefore, the new EVC value would be equal to one (new EVC=0+1). After the data version management module 146 has updated the EVC for the record in step 245, the data version management module 146 may proceed to step 250.

Next, at step 250 the data version management module 146 may insert the new record in the buffer (i.e., the record with the data received in step 205 and the new EVC value) into the database table 158.

### An Exemplary Database Table with Encoded Version Column

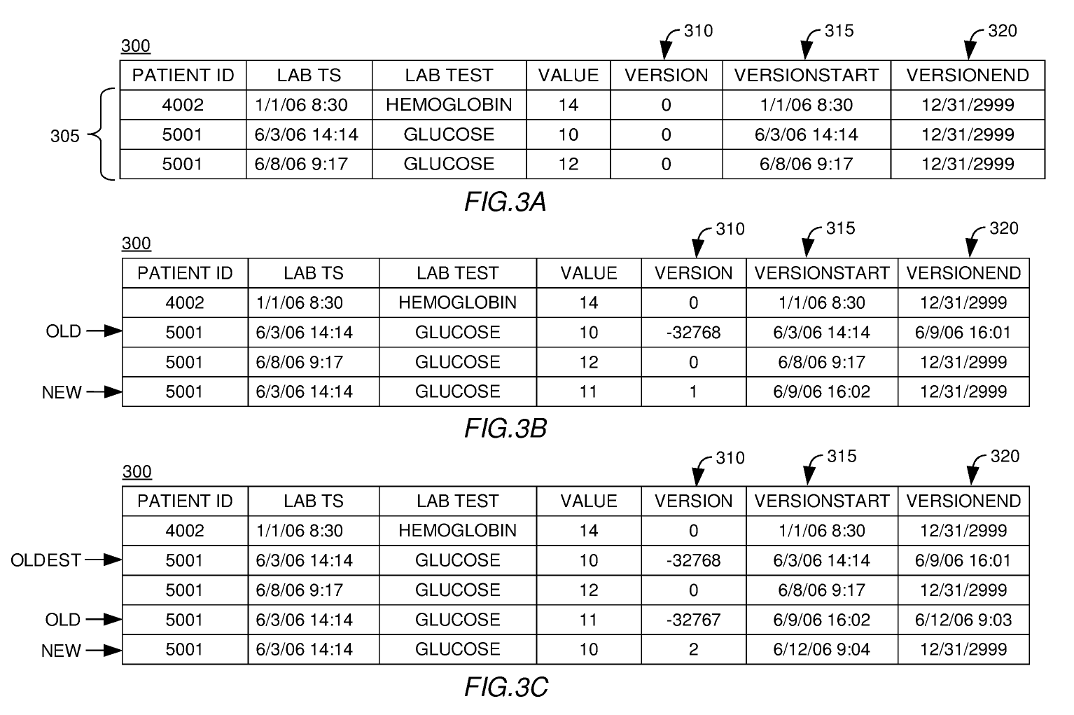

FIG. 3A is an exemplary database table 300 containing records 305. The records 305 contain an encoded version column 310, according to one embodiment of the invention. The database table 300 may be located in a database 156₁ similar to the one described with reference to FIG. 1. All of the records in the database table 300 in FIG. 3A are original records as can be determined by examining the EVC value of each record. Since the EVC value of each record is zero, all of the records in the database table 300 are original records. All of the records also contain a version start column 315 and a version end column 320, which are present to aid description.

FIG. 3B illustrates the same database table 300, except that a new version of one of the records has been added to the database table 300. In this example, on 06/09/06 at 16:02, the glucose data for the 5001 patient from 06/03/06 is changed from 10 to 11. This database record may have been changed, for any reason. For example, the database record may have been changed due to a keying error. Furthermore, the EVC value of the original record (now the old record) has been changed because it is no longer the most current version of the record. In the illustrative embodiment, the EVC value of the original record has been changed to the smallest integer value for the EVC field. In this example the smallest integer value for the EVC field is −32768, as can be seen in the EVC column 310 of the old version of the record.

The EVC value of the new version of the record has been set to 1. The new EVC value has been determined by incrementing the original record's EVC value by one integer value. The new EVC value (i.e., 1) reflects the number of revisions of the record to date (i.e., one revision). Furthermore, the EVC value of the most current version is the largest EVC value for all records sharing the same primary key. This allows a query of the database table to determine the most recent version of the record by searching for the only positive EVC version value of the record.

FIG. 3C illustrates the database table 300; however, a new version of the 5001 patient's glucose record which has a lab time stamp of 06/03/06 14:14 has again been added to the database table 300. On 06/12/06 at 9:04 AM, the glucose data for the 5001 patient from 06/03/06 was changed again. In this case, the value of the Glucose level has been changed from 11 to 10. Accordingly, the EVC value of the record created on 06/09/06 at 16:02 has been changed because it is no longer the most current version of the record. Specifically, the EVC value of the revised record created on 06/09/06 at 16:02 has been changed from a value of 1 to a new EVC value of −32767(−32767=1 −32768). The EVC value of the original record (−32768) is not changed. The EVC value of the original record is not changed in order to retain a temporal ordering of the records based on EVC value alone. Therefore, the oldest record, the original record, has the smallest (i.e., most negative) EVC value.

The EVC value of the new version of the record has been set to 2. The EVC value of the new record has been calculated by incrementing by one the older record's EVC value (2=1+1). The new EVC value (i.e., 2) reflects the number of revisions of the record to date (i.e., two revisions). Furthermore, the EVC value of the most current version of the record is the largest EVC value for all records relating to the original record, and the EVC value of the most current version of the record is the only positive EVC value for all records relating to the original record.

### Searching a Database Table with Encoded Version Column

The use of an encoded version column and encoded version column values in a database table facilitates and expedites searching for different versions of records within the database table, according to embodiments of the present invention. For example, the use of an encoded version column ensures that a record with an EVC value that is positive is the most current version of the record. Therefore, a query which searches for a record with a positive EVC value will return the current version of the record. An example of a search query is: SELECT LAB_TS, LAB_TEST, VALUE, VERSION FROM LAB_TESTS WHERE PATIENT_ID=5001 AND EVC>=0. This query returns all records from a LAB_TESTS database table with a PATIENT_ID value equal to 5001 and with an EVC value greater than or equal to zero (i.e., non-negative). When applied to the exemplary database table 300 illustrated in FIG. 3C the query may return the results illustrated in Table 1 below. The results in Table 1 reflect all records within database table 300 that satisfy the query.

TABLE 1
Exemplary Query Results

| LAB_TS | LAB_TEST | VALUE | VERSION | VERSIONSTART | VERSIONEND |
|---|---|---|---|---|---|
| 6/3/06 14:14 | GLUCOSE | 10 | 2 | 6/12/06 9:04 | Dec. 31, 2999 |
| 6/8/06 9:17 | GLUCOSE | 12 | 0 | 6/8.06 9:17 | Dec. 31, 2999 |

Furthermore, the EVC value of the most current version of the record represents the number of times the record has been updated. In the example above the value of the most current instance of the 6/3/06 record is 2, indicating that the record has been updated twice.

Using the EVC values according to embodiments of the present invention allows one to quickly determine if a record is the most current version. For example, if the EVC value of a record is negative, the record is not the most current version of the record; however, if the EVC value for a record is not negative (i.e., zero or positive) then the record does reflect the most current version.

Another benefit of the EVC values, according to embodiments of the present invention, is that different versions of records can be ordered using the EVC values of the records. For example, by sorting related records in ascending order from the record with the smallest EVC value to the record with the largest EVC value, one may obtain a list of the EVC records in the order in which they were created.

Determining the ordinal position of any arbitrary record within a database table using an EVC may be calculated from the EVC value. For example, if the EVC value of a record is negative, the ordinal position may be calculated by adding one plus the largest possible integer value for the EVC to the EVC value of the record. The result will be the ordinal position of the record. If the EVC value of the record is nonnegative, then the EVC value is the ordinal position of the record.

Furthermore, in order to maintain the integrity of data between several tables, the EVC may be appended to the original primary key and foreign key column of each of the tables. For example, in FIG. 3C if we assume that the primary key of the table before versioning was added was the PATIENT_ID and LAB_TS columns, we could create a new table with versioning that has PATIENT_ID and LAB_TS, and VERSION as the primary key.

In addition to maintaining the integrity of versioned data, a table with the version column within the foreign key can interrogate the EVC (without actually performing a join to the table that has the EVC in the primary key) to determine the versioning attributes of the records within the primary key table. For example, version determinations include whether the record is the current version, what version the record is, or if the record is the original version. Furthermore, the database optimization technique of using key only access (using an index without accessing the table at all) can be used in conjunction with an EVC value to determine the versioning attributes of the records within the primary key table. Due to the fact that the EVC is part of the primary key, an index may be created for it in that role, which may enable quick positioning to the current record.

Tables can be partitioned using the EVC by specifying the EVC in a partitioning key. A partitioning key is a column or group of columns that is used to define the partition that a record should belong to. A partition is a defined subset of a table that can be used to improve performance and manageability of a (typically large) database table. By using an EVC as part of a partitioning key, current data can easily be separated from other (non-current) data.

### Conclusion

Embodiments of the present invention provide techniques for optimizing access to different versions of records within a database. An encoded version column within a database table and an algorithm which calculates encoded version column values corresponding to records are provided according to one embodiment of the invention. Furthermore, the algorithm calculates the encoded version column value according to the order in which records have been entered into the database. The use of the algorithm results in all records containing non-current data having negative encoded version column values, and all records containing current data having non-negative encoded version column values. Furthermore, if a current record is the original record the algorithm assigns the record an EVC value of zero. Subsequent searches of the data within the database may return the most current version of the record by simply searching for the desired data record which has a non-negative EVC value. The use of the EVC and the EVC value algorithm result in an efficient technique for tracking versions of records within a database and an optimized way to search for current records within the database.

While the foregoing is directed to embodiments of the present invention, other and further embodiments of the invention may be devised without departing from the basic scope thereof, and the scope thereof is determined by the claims that follow.

What is claimed is:

1. A method of versioning data in a database, comprising:
storing data in a first record of a database table having an encoded version column, wherein the first record has an encoded version column value;
receiving revised data for the first record;
creating a second record for the revised data, wherein the second record has an encoded version column value;
calculating a first adjusted encoded version column value from the encoded version column value of the first record;
associating the first adjusted encoded version column value with the first record;
calculating a second adjusted encoded version column value from the encoded version column value of the first record; and
associating the second adjusted encoded version column value with the second record; wherein the adjusted encoded version column values identify the relative versions of the first and second records.

2. The method of claim 1, wherein calculating a second adjusted encoded version column value from the encoded version value of the first record results in a non-negative second adjusted encoded version column value.

3. The method of claim 1, wherein calculating a second adjusted encoded version column value from the encoded version value of the first record comprises incrementing the encoded version value of the first record by one.

4. The method of claim 1, wherein calculating a first adjusted encoded version column value from the encoded version column value of the first record results in a negative first adjusted encoded version value.

5. The method of claim 1, wherein calculating a first adjusted encoded version column value from the encoded version column value of the first record comprises, adding an integer value of the encoded version column from the encoded version column value of the first record.

6. The method of claim 5, wherein the integer value is the smallest possible negative integer value of the encoded version column.

7. The method of claim 1, wherein the encoded version column value of the first record is initially zero.

8. The method of claim 1 further comprising,
requesting to execute a query against the database table;
returning results comprising at least one record from the database table; and
sorting the results according to their encoded version column value.

9. The method of claim 1 further comprising,
determining an ordinal position of a record within the database table, wherein determining an ordinal position comprises:
if the encoded version column value of the record is negative, the ordinal position is determined by adding one plus a largest possible value for the encoded version column to the encoded version column value of the record; and
if the encoded version column value for the record is nonnegative, the ordinal position of the record is the encoded version column value.

10. A computer readable storage medium containing a program which, when executed, performs operations for generating a version value for records in a database, the operations comprising:
storing data in a first record of a database table having an encoded version column, wherein the first record has an encoded version column value;
receiving revised data for the first record;
creating a second record for the revised data, wherein the second record has an encoded version column value;
calculating a first adjusted encoded version column value from the encoded version column value of the first record;
associating the first adjusted encoded version column value with the first record;
calculating a second adjusted encoded version column value from the encoded version column value of the first record; and
associating the second adjusted encoded version column value with the second record; wherein the adjusted encoded version column values identify the relative versions of the first and second records.

11. The computer readable medium of claim 10, wherein calculating a second adjusted encoded version column value from the encoded version value of the first record results in a non-negative second adjusted encoded version column value.

12. The computer readable medium of claim 10, wherein calculating a second adjusted encoded version column value form the encoded version value of the first record comprises incrementing the encoded version value of the first record by one.

13. The computer readable medium of claim 10, wherein calculating a first adjusted encoded version column value from the encoded version column value of the first record results in a negative first adjusted encoded version value.

14. The computer readable medium of claim 10, wherein calculating a first adjusted encoded version column value from the encoded version column value of the first record comprises, adding an integer value of the encoded version column from the encoded version column value of the first record.

15. The computer readable medium of claim 14, wherein the integer value is the smallest possible negative integer value of the encoded version column.

16. The computer readable medium of claim 10, wherein the operations further comprise:
requesting to execute a query against the database table;
returning results comprising at least one record from the database table; and
sorting the results according to their encoded version column value.

17. A system, comprising:
A processor; and
a memory containing a database table, wherein the database table comprises:
a plurality of records and a plurality of columns wherein at least one column is an encoded version column containing encoded version column values that indicate a relative version of the records within the database table;
a first record that contains a nonnegative encoded version column value; and
a second record relatively older than the first record with a negative encoded version column value.

18. The system of claim 17, wherein the system further comprises:
a database version management module, wherein the database version management module is configured perform operations, the operations comprising:
storing data in a first record of a database table having an encoded version column, wherein the first record has an encoded version column value;
receiving revised data for the first record;
creating a second record for the revised data, wherein the second record has an encoded version column value;
calculating a first adjusted encoded version column value from the encoded version column value of the first record;
associating the first adjusted encoded version column value with the first record;
calculating a second adjusted encoded version column value from the encoded version column value of the first record; and
associating the second adjusted encoded version column value with the second record; wherein the adjusted encoded version column values identify the relative versions of the first and second records.

19. The system of claim 18, wherein the operations further comprise:
requesting to execute a query against the database table;
returning results comprising at least one record from the database table; and
sorting the results according to their encoded version column value.

20. The system of claim 17, wherein the database table further comprises a primary key, wherein the encoded version column is appended to the primary key.
